(19) United States
(12) Patent Application Publication
(10) Pub. No.: US 2026/0235863 A1
(43) Pub. Date: Aug. 13, 2026

(54) Lens Cover for Night Vision Device

(71) Applicant: James P. Rosengarth, Raleigh, NC (US)

(72) Inventor: James P. Rosengarth, Raleigh, NC (US)

(21) Appl. No.: 19/050,034

(22) Filed: Feb. 10, 2025

(51) Int. Cl. G02B 23/16; G02B 23/12

(52) U.S. Cl. CPC G02B 23/16; G02B 23/12

(57) ABSTRACT

A lens covers for night vision devices including a rigid annular mounting collar and a separate end cap interconnected by a pair of elastic O-rings. The mounting collar is affixed to the tubular NVD housing behind the lens adjustment dial spaced from the objective lens of the NVD housing. The use of elastic O-rings and the two piece end cap and mounting collar design allows the end caps to be manually moved between a closed position covering the objective lens and an open position spaced from the objective lens without obstructing the user's access to the adjustment dials. In the open operational position, while the end caps are positioned adjacent the lens adjustment dial the mounting collar is spaced from the lens adjustment dial, so as to allow a user ready manual access to the lens adjustment dial.

This invention relates to lens covers and particularly lens covers for objective and thermal lenses of night vision devices.

### BACKGROUND AND SUMMARY OF INVENTION

Night vision devices (“NVDs”) generally include tubular housings that enclose image intensifier tubes, an object lens and an adjustable object lens dial at the distal end of the housing. Night vision devices generally use lens covers to cover and protect the delicate objective and thermal lenses from dirt and debris, as well as physical damage. Heretofore, conventional NVD lens covers are fitted to the ends of the NVD housing to cover and enclose the object lens. Often conventional NVD lens covers are separate caps fitted to the ends of the lens housings, which must be stowed on the user's person when the NVD is in use. Other conventional NVD lens covers are tethered to the NVD itself or connected by elastic bands that allow the cover to be manually moved between a closed position covering the objective and thermal lenses and an open stowed positioned away and adjacent the lenses. A significant issue with conventional tethered lens covers is that the covers often obstruct the user's access to the objective lens adjustment dials.

The lens covers of this invention include a rigid annular mounting collar and a separate end cap interconnected by a pair of elastic O-rings. The mounting collar is affixed to the tubular NVD housing behind the lens adjustment dial spaced from the ends of the objective and thermal lens housings. The use of elastic O-rings and the two piece end cap and mounting collar design allows the end caps to be manually moved between a closed position covering the lenses and an open position spaced from the lenses without obstructing the user's access to the adjustment dials. In the open operational position, while the end caps are positioned adjacent the lens adjustment dial the mounting collar is spaced from the lens adjustment dial, so as to allow a user ready manual access to the lens adjustment dial.

These and other advantages will become apparent upon a reading of the following description.

### Brief Description of the Drawings

The preferred embodiments of the invention have been depicted for illustrative purposes only wherein:

FIG. 1 is a front perspective view of an exemplary embodiment of two lens covers of this invention mounted to a conventional quad tube night vision device in the closed protective position;

FIG. 2 is another front perspective view of the two lens covers of FIG. 1 in the open operational position.

FIG. 3 is a front view of another exemplary embodiment of the lens covers of this invention mounted to a conventional dual tube night vision device in the closed protective position;

FIG. 4 is another front view of the lens covers of FIG. 3 in the open operational position;

FIG. 5 is a front top perspective view of the lens cover of FIG. 1;

FIG. 6 is a rear top perspective view of the lens cover of FIG. 1;

FIG. 7 is a top view of the lens cover of FIG. 1;

FIG. 8 is a bottom view of the lens cover of FIG. 1:

FIG. 9 is a left side view of the lens cover of FIG. 1; and

FIG. 10 is a right side view of the lens cover of FIG. 1.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

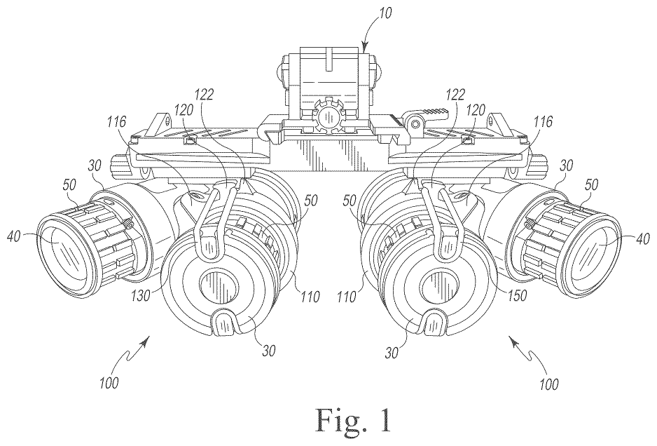

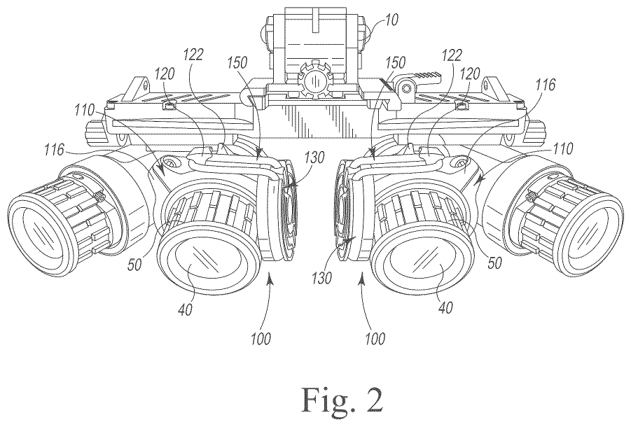

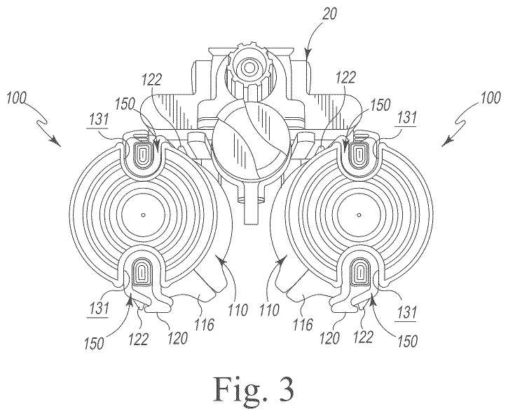

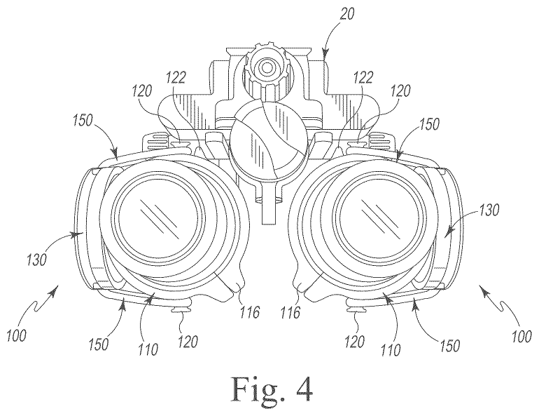

Referring now to the drawings, FIGS. 1-4 illustrate an exemplary embodiment of the lens covers of this invention, which are designated generally as reference numeral 200. Lens covers 200 are designed and intended to cover and protect the objective and thermal lens of infrared and thermal night vision devices (“NVDs”), without obstructing access to the objective lens adjustment dials of conventional NVDs. FIGS. 1-4 illustrate lens covers 100 in use on an exemplary quad tube infrared night vision device 10, such as *GPNVG-ANVIS Panoramic night vision goggles (FIGS. 1 and 2) and an exemplary dual or binocular night vision device 30, such as the AN/PVS-31A (FIGS. 3 and 4), both manufactured by L3 Harris Technologies, Inc. of Melbourne, Florida.

Each lens cover 100 includes an annular mounting collar 110 and a separate end cap 130 interconnected by a pair of elastic O-rings 150. Mounting collars 110 are affixed to tubular NVD housing 30 behind the lens adjustment dial 50 and spaced from the distal objective lens 40 of each NVD housing. The use of elastic O-rings and the two piece end cap and mounting collar design allows the end caps to be manually moved between a closed protective position (FIGS. 1 and 3) and an open operational position spaced from the objective lens (FIGS. 2 and 4) without obstructing the user's access to the adjustment dials 50. While the end caps are positioned adjacent the lens adjustment dial in the open operational position, mounting collars 110 are spaced from the lens adjustment dials 50, so as to allow a user ready manual access to the lens adjustment dial.

Mounting collar 110 and end cap 120 are formed, molded or fabricated from a suitable light-weight polymer material, but in certain embodiments may be stamped, formed or machined from suitable light-weight metals, such as aluminum. Mounting collar 110 has a one-piece annular split body design with spaced ears 116 clamped together by a threaded bolt (not shown). Mounting collar 110 also has a pair of integral hook shaped O-ring retention members 120 and a pair of O-ring protection protrusions 122 that extend from each collar half 110. As shown, retention members 120 and protection protrusions 122 are aligned on opposites sides of mounting collar 110. Retention members 120 have a hook shaped vertical cross section and extend outward from collar halves 112 to receive and retain one of O-rings 150. Protection protrusions 122 have a triangular cross section and extend outward from collar halves 112 adjacent retention members 120. Cover cap 130 is configured to cover and enclose the objective lens 40 of night vision devices and has a generally round planar body with a flat bottom and flat round top with sloped sides. Cover cap 130 has a pair of U-shaped recessed channels 131 formed on opposed sides of the cap, which are configured to restrictively receive part of O-rings 150.

O-rings 150 are generally conventional elastic O-rings, used as seals or gaskets in many other applications. Within the teachings of this invention, O-rings 150 are elastic members that connect end cap 130 to collar 110 and allow the end cap to be manually moved between a closed protective position where the cap covers and encloses objective lens 30 of the night vision device 10 and an open operational position where the end cap is spaced from the objective lens 30. O-rings 150 are selected to have sufficient resilience and elasticity to allow cap 130 to be manually displaced between the closed protective position (FIGS. 2 and 4) and the open operational position, as well as. to securely hold the cap against the objective end of housing 30 in the closed position (FIGS. 1 and 3) to prevent damage or exposure to the objective lens. In other embodiments, other elastic members may be used to connect cap 130 to mounting collar 110. As shown, one end of each O-ring 150 is stretched around retention members 120 on mounting collar 110 and the other end is restrictively seated within channel 131 of cap 130. Protective protrusions 122 are spaced away from O-rings 150, but positioned to protect the o-rings from being dislodged from retention members 120 by contact with foreign objects and the like.

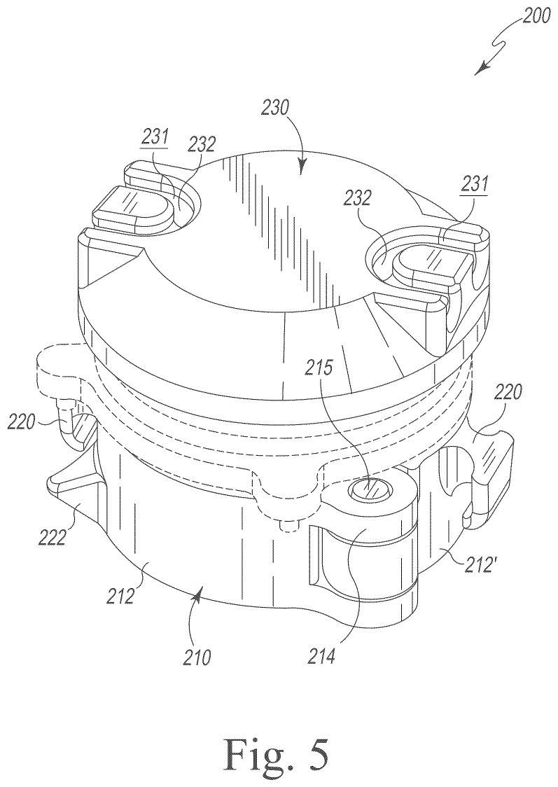

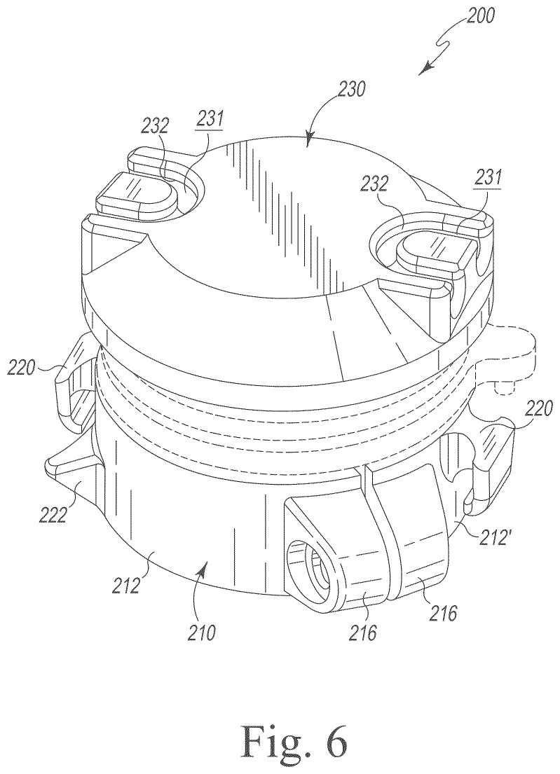

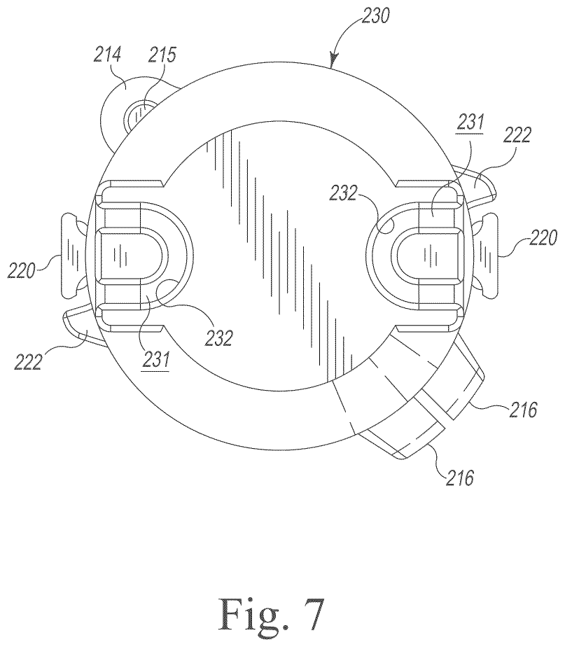

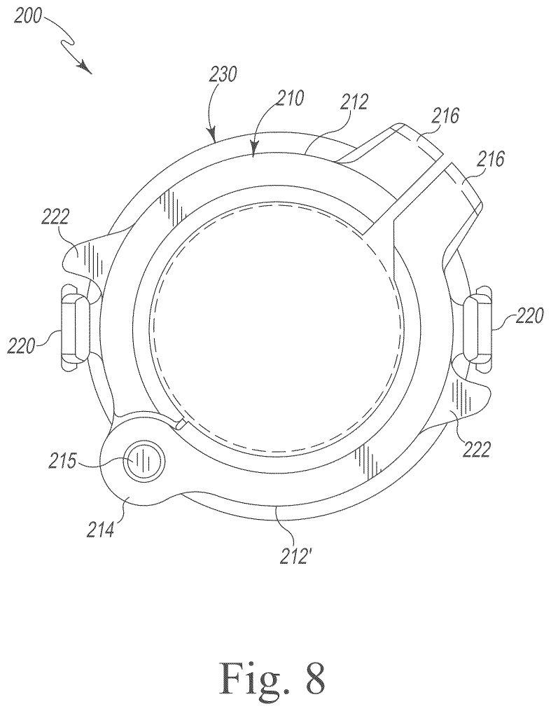

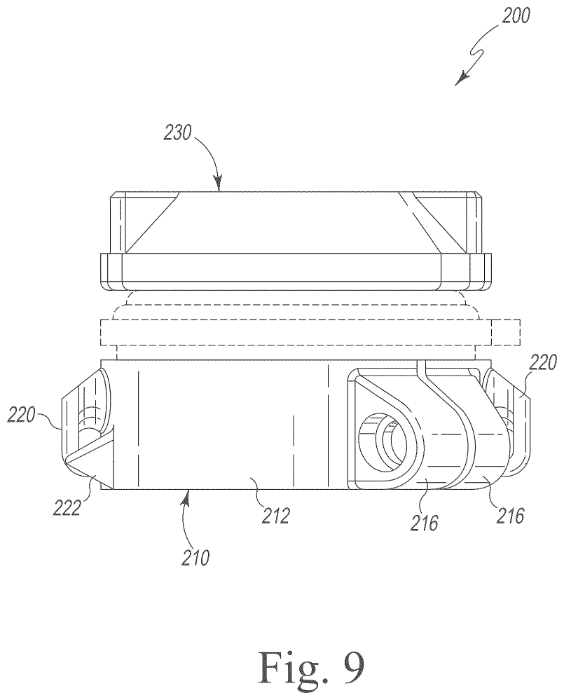

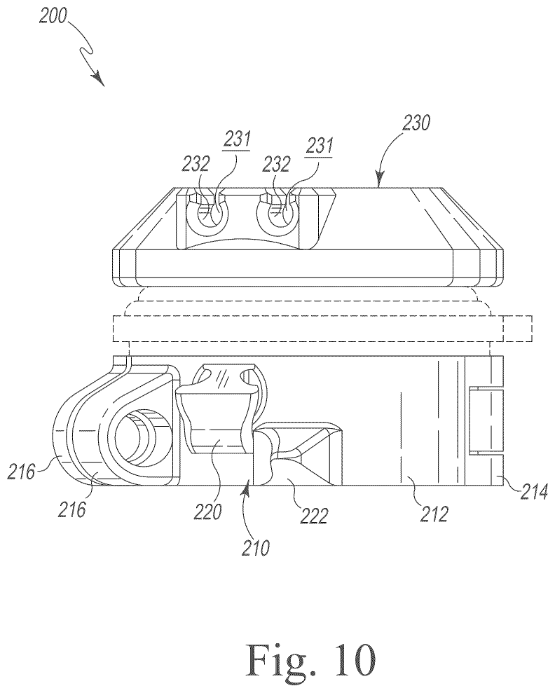

FIGS. 5-10 illustrate a second exemplary embodiment of the lens cover of this invention, designated as reference numeral 200, which are designed and intended for use with a thermal lens cover for an enhanced night vision binocular google, such as the ENVG-B from L3 Harris Technologies (shown partially in dashed lines). Again, lens cover 200 includes an annular mounting collar 210 and a separate end cap 230 interconnected by a pair of elastic O-rings (not shown). Mounting collars 210 are adapted to affix to thermal sensor housing (not shown) behind the lens adjustment dial of the NVD and spaced from the distal thermal lens.

Again, mounting collar 210 and end cap 230 are formed, molded or fabricated from a suitable light-weight polymer material, but in certain embodiments may be stamped, formed or machined from suitable light-weight metals, such as aluminum. Mounting collar 210 uses a two-piece annular body design, which includes a pair of identical collar halves 212. Each collar half 212 terminates at one end in corresponding hinge ears 214 and clamping ears 216 at the opposite end. Collar halves 212 are pivotally connected at one end by a pivot pin 215 that extends through aligned bores in corresponding hinge ears 214 and are clamped together on the opposite end by a threaded bolt 217 extending through aligned bores in clamping ears 216 that turns into an internally threaded sleeve (not shown) that is press fit into the clamping ear.

Mounting collar 210 also has a pair of integral hook shaped O-ring retention members 220 and a pair of O-ring protection protrusions 222 that extend from each collar half 212. As shown, retention members 220 and protection protrusions 222 are aligned on opposite sides of mounting collar 210. Retention members 220 have a hook shaped vertical cross section and extend outward from collar halves 212 to receive and retain one of the O-rings (not shown). Protection protrusions 222 have a triangular cross section and extend outward from collar halves 212 adjacent retention members 220.

Cover cap 230 is configured to cover and enclose the thermal lens of the night vision device (not shown) and has a generally round planar body with a flat bottom and flat round top with sloped sides. Cover cap 230 has a pair of U-shaped recessed channels 131 formed on opposed sides of the cap, which are configured to restrictively receive part of the O-rings. The channel walls 232 that define channels 231 are rounded and contoured to restrictively seat the O-rings.

As with lens covers 100, the elastic O-rings 150 allow the end cap 230 to be manually moved between a closed protective position where the cap covers and encloses the thermal lens of the night vision device and an open operational position where the end cap is spaced from the thermal lens.

In both embodiments of the lens covers, the use of a two piece lens cover design and the elastic O-rings allow the mounting collars to be clamped around each tubular housing and spaced from and behind the lens adjustment dials to provide ready access to the adjustment dials regardless of the position of the end caps. The elasticity of the O-rings allows the O-rings to stretch and span the distance between the mounting collars and end caps, thereby accommodating for differing widths of objective lens adjustments. In the closed protective position, the elastic O-rings securely hold the end caps against objective and thermal lenses and a user can manually access lens adjustment dials through the O-rings as necessary, In the closed protective positions, the elastic O-rings hold and stow the end caps adjacent the sides of the housings with space for the user to manually access and turn the lens adjustment dials around the end caps. The ability to access and turn the lens adjustment dials is critical to the use and operation of NVDs, particular in low light conditions where tactile manipulation and operation of the NVDs is essential. The locations and attachment of neither the mounting collars nor the end caps effect or alter the use of lens adjustment dials or the operation or use of the NVDs.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A lens cover affixable to a night vision device, where the night vision device includes a tubular image intensifier housing having a first end thereof and a second end thereof spaced from the first end, and an annular objective lens adjustment dial located adjacent the first end of the image intensifier body, the cover comprising:
an annular mounting collar adapted to detachably mount to the image intensifier body of the night vision device between the first end of the image intensifier and the second end of the image intensifier housing and adjacent the objective lens adjustment;
an end cap having a cap body configured to enclose the first end of the image intensifier housing; and
an elastic member connecting the end cap to the mounting collar for movement between an open position where the end cap is spaced adjacent from the first end of the image intensifier housing to allow operative access to the objective lens adjustment when the cover is affixed to the night vision device, and a closed position where the end cap overlies the first end of the image intensifier body when the cover is affixed to the night vision device.

2. The lens cover of claim 1 wherein the elastic member is an O-ring.

3. The lens cover of claim 2 wherein the mounting collar includes a collar retention member extending member for securing the O-ring to the mounting collar.

4. The lens cover of claim 3 wherein the collar retention member is a hook part having a proximal end extending from the mounting collar and distal end spaced over the mounting collar, the O-ring retained about the distal end of the hook part.

5. The lens cover of claim 3 wherein the mounting collar includes a protrusion extending therefrom adjacent the retention member.

6. The lens cover of claim 1 wherein the end cap has a U-shaped retention channel formed therein for restrictively receiving a portion of the O-ring therein to secure the O-ring to the end cap.
